(19) United States
(12) Patent Application Publication
(10) Pub. No.: US 2003/0152037 A1
(43) Pub. Date: Aug. 14, 2003

(54) Method and portable device for determining the stability of radio communications in a wireless lans

(76) Inventor: Justin Howard, Duxford, Cambridge (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/257,602

(22) PCT Filed: Apr. 11, 2001
(86) PCT No.: PCT/EP01/04159

(30) Foreign Application Priority Data
Apr. 13, 2000 (GB) 0009082.9

(51) Int. Cl. H04L 12/28

(52) U.S. Cl. 370/252; 370/310

(57) ABSTRACT

The invention provides a method of determining the stability of a signal parameter (such as throughput) in data transmitted in a wireless LAN. A plurality of values of the parameter are detected over a predetermined time and an average value calculated. The difference between the average value and each of the plurality of values is then determined. The modulus values of the differences are summed and divided by the number in the plurality to obtain a figure representative of stability.

### FIELD OF THE INVENTION

This invention relates to wireless LANs (local area networks) and in particular to a method of determining the stability of a signal parameter in data transmitted in a wireless LAN.

### BACKGROUND TO THE INVENTION

Wireless LANs can exhibit irregular performance in which the reliability and data transfer rate vary rapidly with time. Simple measurements of wireless LAN performance can produce results which do not adequately represent actual performance in practice. The invention aims to define, and provide a measure of, a parameter which represents a more accurate representation of the reliability of the data transmitted.

### SUMMARY OF THE INVENTION

According to the invention there is provided a method of determining the stability of a signal parameter in data transmitted in a wireless LAN, comprising detecting a plurality of values of the parameter over a predetermined period of time, obtaining an average value of the plurality of values, comparing the average value and each of the plurality of values, determine a variance value indicative of the difference between the average value and each of the plurality of values, thereby to obtain a figure representative of stability.

The variance value may be obtained by determining the difference between the average value and each of the plurality of values, summing the modulus values of the differences and dividing the sum thereby obtained by the number in the plurality.

Preferably, said average value is the median of said plurality of values, said plurality being an uneven number.

The parameter is preferably throughput, i.e. the rate of data transmission, and the predetermined time is conveniently between 1 and 3 seconds, most preferably being 2 seconds.

The method may be performed in a site survey tool provided with software for performing the method, and the plurality of values of the parameter are conveniently detected at a corresponding plurality of sample points over an area covered by the wireless LAN.

The invention also includes within its scope a portable computer serving as a site survey tool and programmed to carry out the inventive method.

### BRIEF DESCRIPTION OF THE DRAWINGS

The invention will now be further described, by way of example, with reference to the accompanying drawings, in which:

FIG. 1 is a block diagram showing a site survey tool linked by radio to a LAN, for performing a method according to the invention,

FIGS. 2 to 4 illustrate three possible presentations shown on a display unit of the site survey tool of FIG. 1, and

FIG. 5 is a flow diagram illustrating the steps of the preferred method according to the invention.

### DETAILED DESCRIPTION

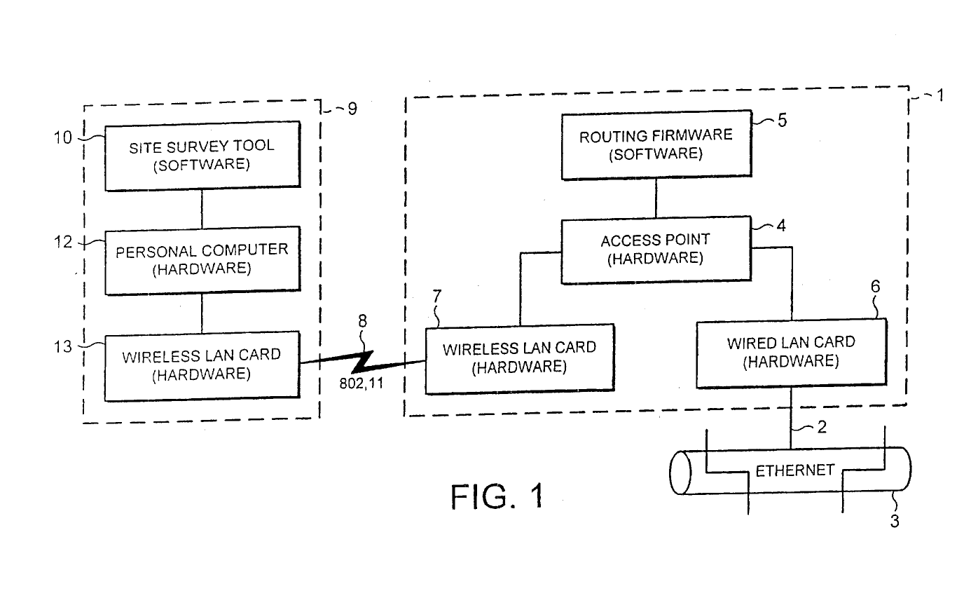

When a building is equipped with a wireless LAN, computers within the building communicate by radio with access points of the LAN, the access points being distributed over the area of radio coverage. In FIG. 1, an access point 1 of a LAN is connected by hard wiring 2 to the remainder 3 of the wireless LAN. At the access point 1, there is hardware 4, routing or bridging firmware 5, a wired LAN card 6 (hardware) at the interface with the remainder 3 of the LAN and a wireless LAN card 7 (hardware) at the radio interface 8 with portable computers. In FIG. 1, a sample area of a building covered by the wireless LAN is being surveyed, so the access point 1 is in radio communication with a portable computer in the form of a site survey tool 9 having software 10, a personal computer 12 including a display unit and a wireless LAN card 13 (hardware) at the radio interface 8. It will be appreciated that this radio interface 8 provides two-way transmission of data between the site survey tool 9 and the access point 1 of the LAN.

By the use of the site survey tool 9, the quality of radio coverage over a sample area of the building can be detected and shown as a visual presentation on the display unit of the site survey tool 9, and also on a display unit of any other computer linked to the LAN.

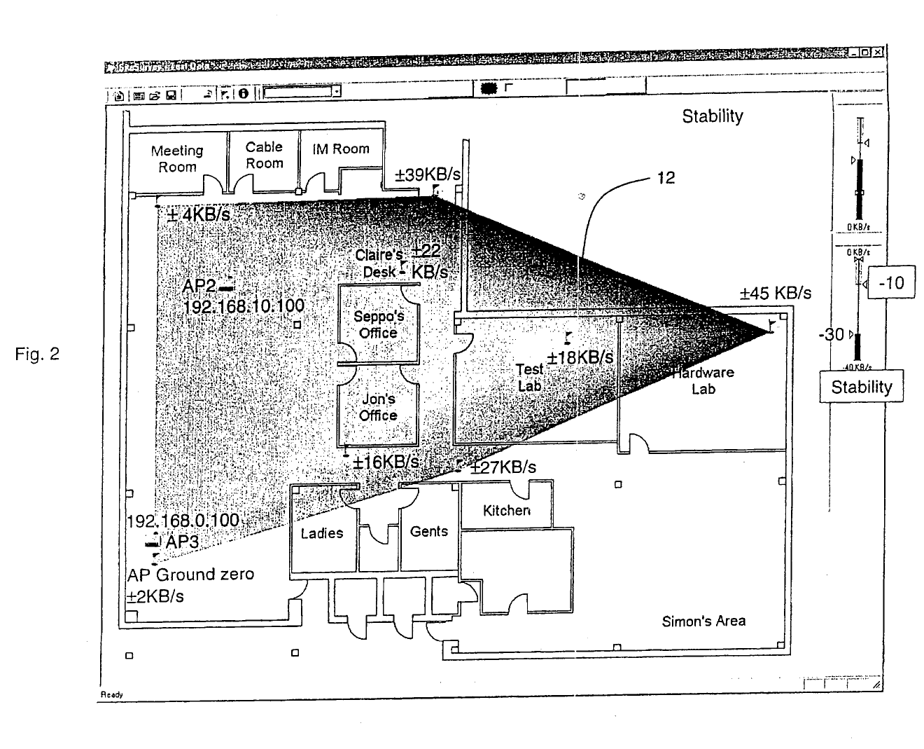

Referring to FIGS. 2, 3 and 4, suppose the area of the building to be surveyed is that within the polygonal shape whose outline is indicated at 12. The outline shape is defined by straight lines drawn between five sample points, and additional sample points are located within the area. The sample points are shown by the flag symbols in FIGS. 2 to 4. A map of the area to be surveyed is entered into the site survey tool software, typically being loaded into the site survey tool 9 from another computer linked to the access point 1. The locations of the sample points are then loaded into the site survey tool software. The site survey tool is then taken to each sample point in turn and a signal parameter is measured at each sample point. In the described method, two parameters are measured and recorded, namely signal stability and signal throughput. Stability is representative of the variation of throughput from an average throughput. Throughput is representative of the rate of received data and is measured in bits per second. Having detected these parameters at the sample points, the software in the site survey tool is able to provide a visual representation (on the display unit of the site survey tool 9) of the variation of each parameter over the sample area. This is done by interpolation, using a gradient fill algorithm. The presentation on the display unit is in colour, green being used to show a desirable value of the parameter and red being used to show an undesirable value of the parameter, the display showing variations in intensity of green and red and showing any transition between red and green as a progressive variation in hue.

FIG. 2, which shows the variation of stability over the sample area, shows red areas as dark and green areas as light, the transition being shown as a variation of a grey colour.

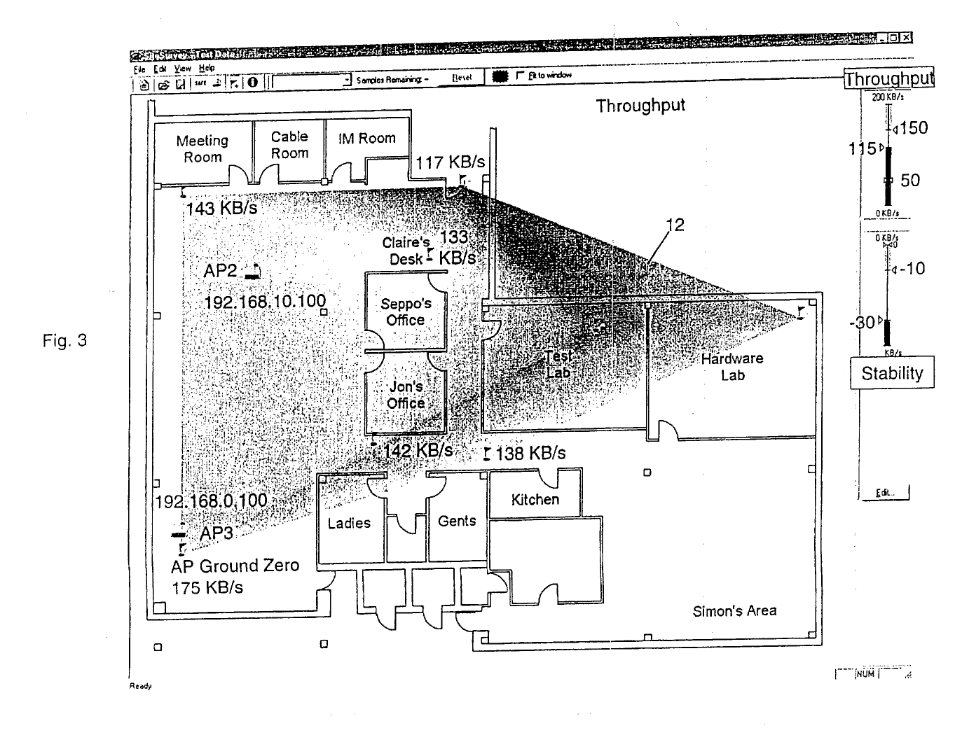

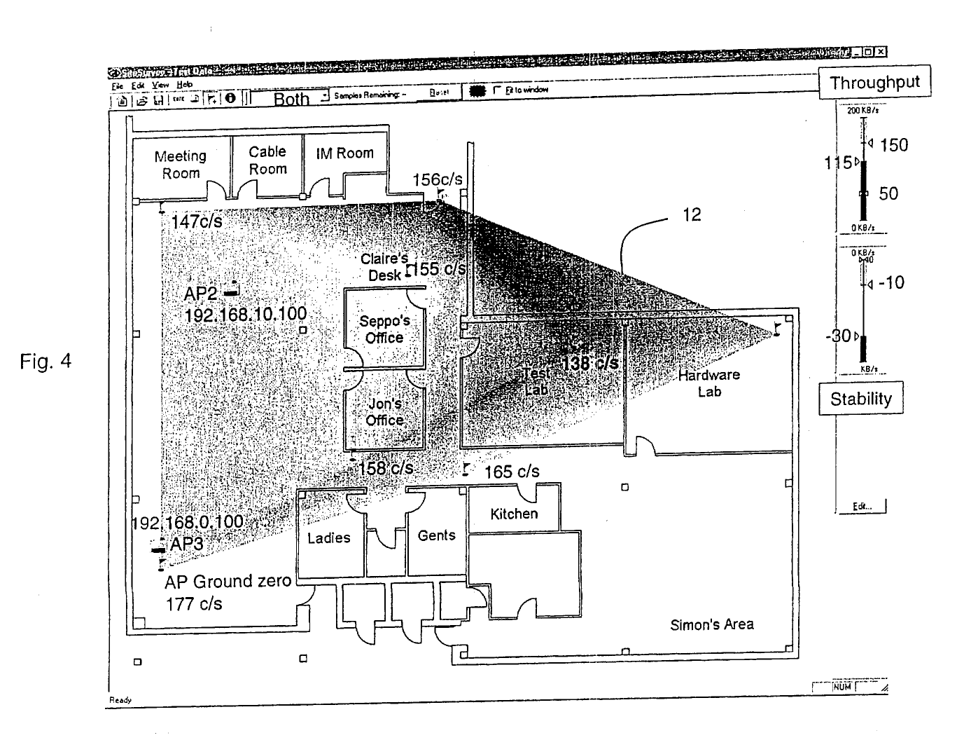

FIG. 3 shows the same area but with the illustrated parameter being throughput, and FIG. 4 shows a composite presentation where the combination of throughput and stability is represented, with each of these parameters providing a 50% weighting to the combined presentation.

The invention provides a new way of defining the parameter of stability, and of measuring it, prior to its display in the manner previously described. Stability is defined as the average variation of throughout over time. Given n samples of throughput in a predetermined time t, stability is defined as a variation in these samples.

For example, if at any one sample point a plurality of values of throughput are sampled over a predetermined time such as two seconds, these samples are accepted into the site survey tool software, as indicated at step 15 in FIG. 5. The sampled values are then placed in numerical order, step 16. Out of the plurality of values, the median value is determined, step 17. The modulus of the difference between each sample and the median is then determined, step 18. The differences detected in step 18 are then summed and divided by the number of samples (step 19) to provide a measure of stability.

The following table sets out an example of seven samples having the values 10, 14, 6, 9, 10, 13 and 11.

| | | | | | | | |
|---|---|---|---|---|---|---|---|
| Sampled Values | 10 | 14 | 6 | 9 | 10 | 13 | 11 |
| Ordered | 6 | 9 | 10 | 10 | 11 | 13 | 14 |
| Difference | −4 | −1 | 0 | 0 | 1 | 3 | 4 |
| Modulus of | 4 | 1 | 0 | 0 | 1 | 3 | 4 |
| Difference | | | | | | | |

Median : 10

Total : 13

Stability : 13/7=±1.86

1. A method of determining the stability of a signal parameter in data transmitted in a wireless LAN, comprising detecting a plurality of values of the parameter over a predetermined period of time, obtaining an average value of the plurality of values, comparing the average value and each of the plurality of values to determine a variance value indicative of the difference between the average value and each of the plurality of values, thereby to obtain a figure representative of stability, and wherein the parameter is throughput, i.e. the rate of data transmission.

2. A method according to claim 1, in which said variance value is obtained by determining the difference between the average value and each of the plurality of values, summing the modulus values of the differences and dividing the sum thereby obtained by the number in the plurality.

3. A method according to claim 2, wherein the average value is the median of said plurality of values, said plurality being an uneven number.

4. A method according to any of the preceding claims, wherein the predetermined time is between 1 and 3 seconds, preferably substantially 2 seconds.

5. A method according to any of the preceding claims, wherein the method is performed in a site survey tool provided with software for performing the method.

6. A method according to any of the preceding claims, wherein the plurality of values of the parameter are respectively detected at a corresponding plurality of sample points over an area covered by the wireless LAN.

7. A portable computer serving as a site survey tool and programmed to carry out the method of any of the preceding claims.
